(19) United States
(12) Patent Application Publication
(10) Pub. No.: US 2004/0259496 A1
(43) Pub. Date: Dec. 23, 2004

(54) Construction project data distribution & update system

(76) Inventors: Thomas Nello Giaccherini, Carmel Valley, CA (US); Mark Alan Sturza, Encino, CA (US); James Riley Stuart, Louisville, CO (US)

Correspondence Address: Giaccherini, Post Office Box 1146, Carmel Valley, CA, 93924, US

(21) Appl. No.: 10/459,727

(22) Filed: Jun. 11, 2003

Related U.S. Application Data
(63) Continuation-in-part of application No. 09/579,324, filed on May 25, 2000.
(63) Continuation-in-part of application No. 09/688,997, filed on Oct. 16, 2000.
(63) Continuation-in-part of application No. 09/833,094, filed on Apr. 10, 2001.
(63) Continuation-in-part of application No. PCT/US01/14828, filed on May 23, 2001.
(63) Continuation-in-part of application No. 09/948,021, filed on Sep. 6, 2001.
(63) Continuation-in-part of application No. 10/094,943, filed on Mar. 11, 2002.
(63) Continuation-in-part of application No. 10/112,810, filed on Apr. 1, 2002.
(63) Continuation-in-part of application No. 10/112,826, filed on Apr. 1, 2002.
(63) Continuation-in-part of application No. 10/316,976, filed on Dec. 11, 2002, now abandoned.
(63) Continuation-in-part of application No. 10/405,888, filed on Apr. 2, 2003.
(63) Continuation-in-part of application No. 10/411,880, filed on Apr. 10, 2003, now abandoned.
(63) Continuation-in-part of application No. 09/887,570, filed on Jun. 22, 2001, now abandoned.

(30) Foreign Application Priority Data
Dec. 11, 2002 (WO) PCT/GB02/05612

(51) Int. Cl. H04H 1/00

(52) U.S. Cl. 455/3.02; 455/3.01

(57) ABSTRACT

Methods and apparatus for automatically distributing data and updates to wireless terminals using a point-to-multi-point network is disclosed. In one embodiment, data from a domestic source is conveyed by satellite to a remote location, where the data is then broadcast by a transmitter. The data is automatically pushed to wireless terminals located at remote construction sites around the world.

### CROSS-REFERENCE TO RELATED PENDING PATENT APPLICATIONS & CLAIMS FOR PRIORITY

The present Patent Application is a Continuation-in-Part Application, which is related to:

U.S. patent application Ser. No. 09/579,324, filed on May 25, 2000;

U.S. patent application Ser. No. 09/688,997 (CIPA), filed on Oct. 16, 2000;

U.S. patent application Ser. No. 09/833,094 (CIPB), filed on Apr. 10, 2001;

PCT International Patent Application No. PCT/US01/14828, filed on May 23, 2001;

U.S. patent application Ser. No. 09/948,021 (CIPC), filed on Sep. 6, 2001;

U.S. patent application Ser. No. 10/094,943 (CIPE), filed on Mar. 11, 2002;

U.S. patent application Ser. No. 10/112,810 (CIPF), filed on Apr. 1, 2002;

U.S. patent application Ser. No. 10/112,826 (CIPG), filed on Apr. 1, 2002;

U.S. patent application Ser. No. 10/316,976 (CIPJ), filed on Dec. 11, 2002;

U.S. patent application Ser. No. 10/405,888 (CIPK), filed on Apr. 2, 2002;

U.S. patent application Ser. No. 10/411,880 (CIPL), filed on Apr. 10, 2003;

U.S. patent application Ser. No. 10/yyy,yyy (CIPM) filed on Jun. 11, 2003;

U.S. patent application Ser. No. 10/xxx,xxx (CIPN), filed on Jun. 2, 2003;

U.S. patent application Ser. No. 09/887,570 (UltraSecure), filed on Jun. 22, 2001; and

PCT International Patent Application No. PCT/GB2002/005612 (UltraSecure), filed on Dec. 11, 2002.

The Applicants hereby claim the benefit of priority under Sections 119 & 120 of Title 35 of the United States Code of Laws for any and all subject matter shared by the present Application and any of the co-pending Applications listed above.

### FEDERALLY SPONSORED RESEARCH OR DEVELOPMENT

None.

### FIELD OF THE INVENTION

The present invention pertains to methods and apparatus for distributing information wirelessly and automatically to remote construction sites. More particularly, one embodiment of the invention employs satellite links and radio transmitters to automatically broadcast data and updates to workers with wireless terminals in remote locations who do not generally have access to extensive communication infrastructure.

### BACKGROUND OF THE INVENTION

Thousands of workers are at work at construction sites scattered across the world. Many of these workers all require large amounts of information to perform their jobs every day. This information may be recorded on books, charts or other printed or paper documents; and may include maps, plans, manuals or other descriptions of construction tasks or building materials. This information can become outdated easily as plans, tasks or conditions change. Composing, printing and circulating current information can pose an enormous problem.

Hard copies may be augmented by electronic communications, but many remote construction sites in underdeveloped or uninhabited locations have only limited or no communications infrastructure.

None of the conventional systems that are currently available to construction contractors that are presently on the market enables the continuous and automatic “pushed” distribution of real-time information that could be used by workers at remote sites around the world.

The development of this system would constitute a major technological advance, and would satisfy long felt needs and aspirations in the telecommunication and construction industries.

### SUMMARY OF THE INVENTION

The present invention employs networks to automatically distribute information to workers at remote construction sites. As an example, a large engineering firm may be responsible for a nationwide rebuilding project, such as the post-war reconstruction of Iraq. Alternatively, a mining concern may be exploring for gold or diamond deposits in undeveloped regions in South Africa. An oil exploration company may be operating a number of off-shore oil platforms. Each of these projects are based in parts of the world that may have inadequate or generally underdeveloped existing communications facilities.

In one embodiment of the invention, a combination of satellite links and local radio transmitters are used to convey information and updates to workers with wireless terminals. These terminals may include any suitable type of information appliance, including, but not limited to, laptop or tablet computers, personal digital assistants, pagers or cell phones. These wireless terminals include a memory for storing information. The memory stores information required for the construction project.

In one embodiment, content is transmitted using subcarriers or sidebands of conventional FM broadcasts to convey data and/or updates to the wireless receivers. In other embodiments, paging or cellular networks may be utilized to convey many types of content. In yet another embodiment, the information maybe received directly from a satellite broadcast.

In another embodiment of the invention, the point-to-multi-point transmission of information to wireless receivers is complemented by a back-channel from the vehicle to a communications center. This back-channel may provide a secure return communications path for messages back to the network.

An appreciation of the other aims and objectives of the present invention, and a more complete and comprehensive understanding ofthis invention, may be obtained by studying the following description of a preferred embodiment, and by referring to the accompanying drawings.

### A BRIEF DESCRIPTION OF THE DRAWINGS

FIG. 1 is a schematic depiction of one embodiment of the invention, which utilizes satellite and local radio links to automatically push information and updates to workers at remote construction sites.

FIGS. 2, 3, 4 and 5 provide coverage maps for several commercially available satellite services.

FIG. 6 is a schematic diagram of database monitoring software which detects changes in a client's database.

FIG. 7 depicts three different hardware add-ons that enable radio reception.

### A DETAILED DESCRIPTION OF PREFERRED & ALTERNATIVE EMBODIMENTS

I. Overview of the Invention

The present invention comprises methods and apparatus for delivering data, content or information and updates to wireless terminals. These wireless terminals or receivers are operated by workers at domestic or foreign construction sites. These construction sites may be located in remote areas or regions which generally do not have adequate existing communications facilities.

The wireless terminals may comprise any information appliance or device, such as a laptop or tablet computer, a personal digital assistant, a cell phone or a pager. The terminal includes a memory for storing information. In this Specification and in the Claims that follow, the terms “terminal” “wireless terminal” and “receiver” generally encompass any device, appliance, apparatus or means which is capable of receiving and storing data, content or information. In one embodiment of the invention, the information stored in the memory of the wireless terminal is a database.

In general, these receivers may use any suitable kind of memory, including hard drives, flash or solid state memory, floppy discs, tapes, or any other type of storage media.

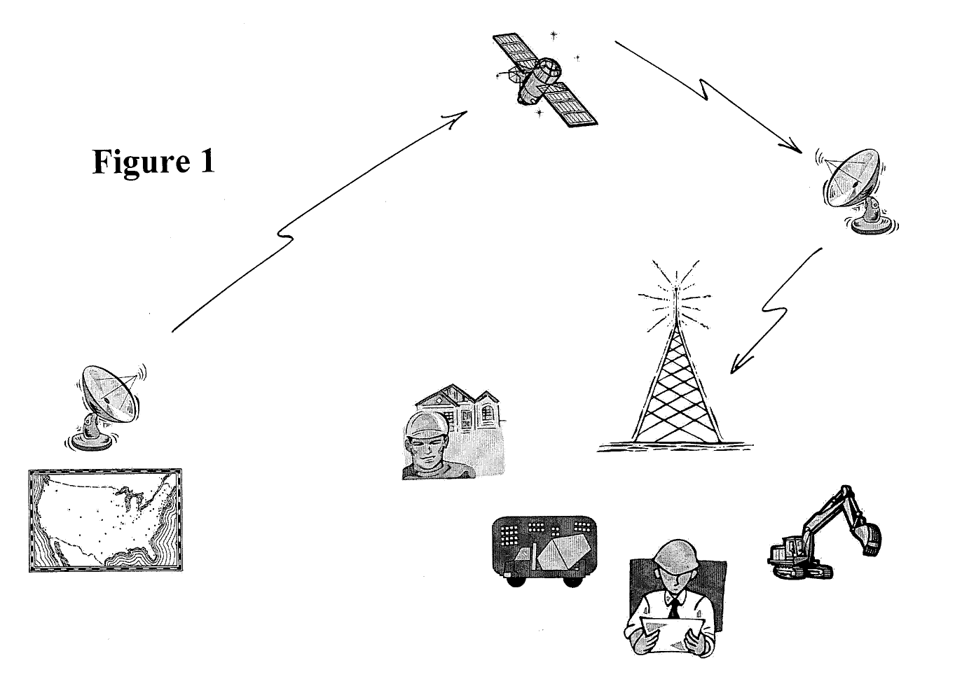

As shown in FIG. 1, a set of information or data is conveyed from a source, such as the headquarters of an engineering firm, up to a satellite and then back down to a satellite dish in a remote location.

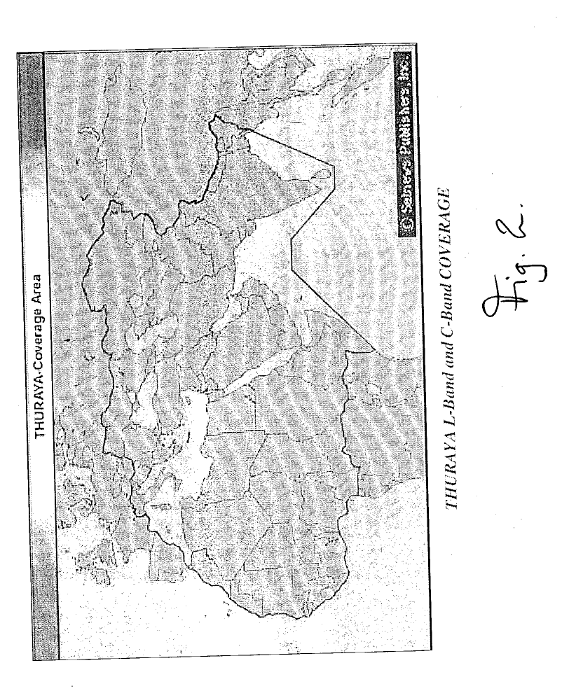

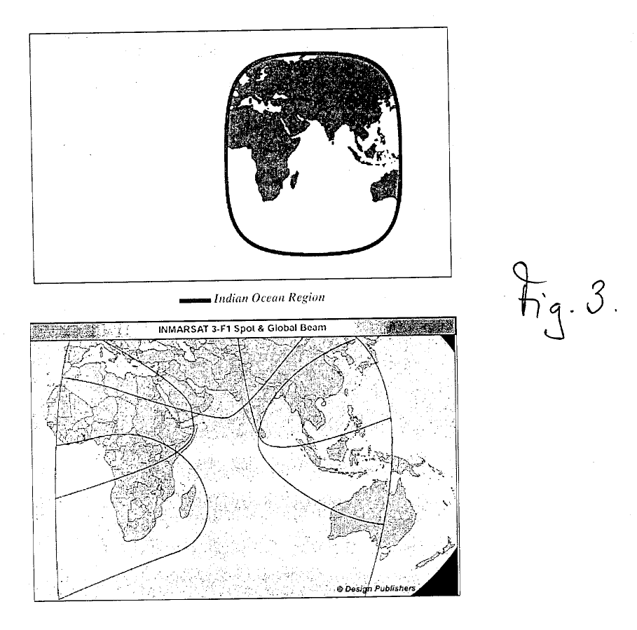

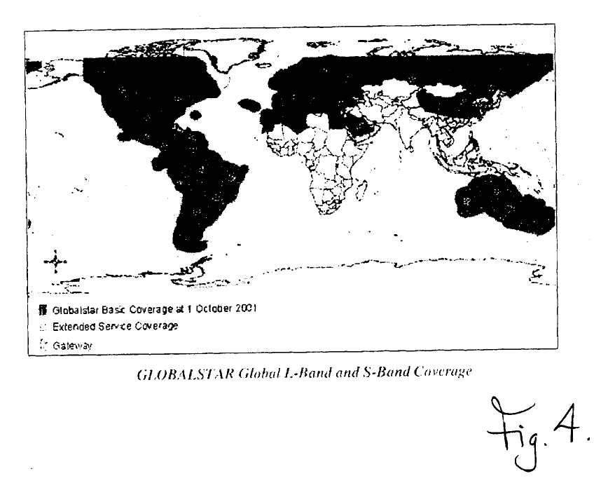

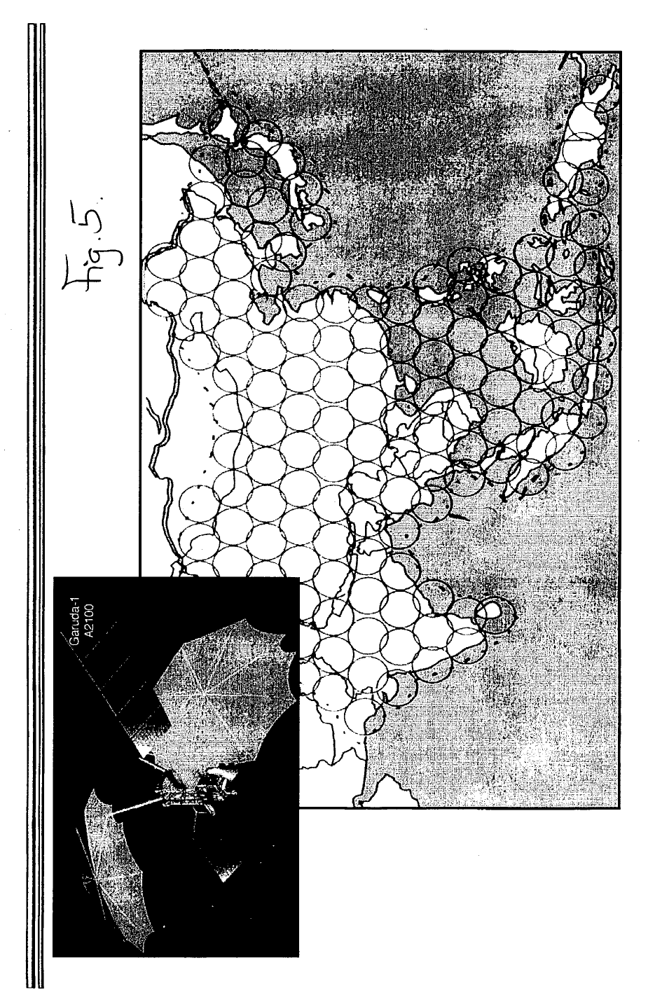

FIGS. 2, 3, 4 and 5 supply coverage maps for various commercially available satellite services that could be used to implement the present invention. FIG. 2 offers a view of the coverage area for the Thuraya satellite, FIG. 3 reveals the footprint for Inmarsat, FIG. 4 shows service regions for Globalstar, and FIG. 5 exhibits a map for the Guruda-1 System.

The information is then conducted over a wired or wireless link to a point-to-multi-point transmitter. This transmitter may be an existing local broadcast facility. As an alternative, a transmitter may be operated from a tractor trailer truck. Finally, the information is automatically, and generally continuously broadcast or “pushed” to a plurality of wireless terminals. Workers operating the wireless terminals receive a continuous, currently updated stream of information that enables them to complete their construction tasks. Software filters provide a means for selecting portions of the information stream to be stored on each individual wireless receiver.

Currently, much of the information that these workers need may be accessed on computers connected to the Internet. Most of these computers are non-mobile, desktop devices. This is an adequate method of accessing information for persons who are able to use computer terminals, but the information must be sought out or “pulled” to the user. It is far more convenient, productive and cost-effective for each individual to have all the information they need “pushed” to them continuously, automatically and without user programming or intervention, whether they use fixed or mobile devices.

In general, the term “pull” pertains to an information or data retrieval process in which a user must take affirmative steps to log onto a network, search for, find, and then download desired information every time information is needed. When information is pulled, a relatively expensive and inefficient point-to-point connection is required. In sharp contrast, the term “push” pertains to an automatic, unidirectional information or data flow which is generally continuous and obviates the need for user action or intervention. A terminal which receives a “pushed” flow of information can utilize a point-to-multi-point data distribution architecture, which is generally much more efficient, less expensive and productive than a “pull” system.

Some information can currently be furnished to individuals using wireless terminals by conventional cell phone systems or private wireless networks like Wi-Fi or 802.11b. Unlike conventional cell phone systems, which require expensive two-way connections, the present invention enables continuous, automatic, asymmetric and very inexpensive flows of data, since the invention uses the excess capacity in previously capitalized and operating networks. Unlike Wi-Fi or 802.11b systems, which have extremely limited ranges, the present invention can bathe huge regions or even countries with ubiquitous streams of data.

One embodiment of the invention utilizes the unused, excess capacity that is inherent in virtually all communication networks. In this Specification and in the Claims that follow, the terms “data” “content” and “information” encompass any form of text, numbers, image, signal, code, audio, video, music, games, software, graphics or other manifestation of intelligence, perception, indication, measurement, reception, sensation, knowledge, pattern or expression.

In one implementation of the invention, the set of information that may be transported to the wireless receivers may include, but is not limited to, maps, charts, schedules, plans, permits, inspection reports, delivery schedules, descriptions of building materials or parts, employee and contractor information, time and work records, vehicle and equipment lists, manuals, guides, status or progress reports; time-critical project, task, milestone or replanning information; or any other information or data concerning the construction project.

The invention may be used to deliver information or databases, or may be used to convey updates to information or databases that may already be stored on the wireless terminals.

The term “update” refers generally to supplying a changed, modified, revised or otherwise different value, form, version or attribute of data or information. The frequency of the update may depend on the rate of change of the information that is updated. The frequency of the updates is not intended to be restricted to any minimum rate or occurrence, so that the invention includes situations where the frequency of updates may be hourly, daily, weekly or monthly. In general, the terms “frequent” “relatively frequent” or “generally continuous” updates embrace the notion that the invention is most valuable when implemented in a setting where the information changes often, rendering physical copies or books inconvenient or less than optimal.

The term “database” pertains generally to any table, listing, compendium, compilation, listing, schedule, pattern, assemblage or association of data that includes any and all data, information, or content as defined in this Specification.

In one embodiment of the invention, information is conveyed to the wireless terminals using excess capacity in an existing network. This network may comprise any point-to-multipoint broadcast means. As particular examples, a suitable broadcast means may include, but is not limited to, AM, FM, cell phone, paging, television or satellite transmissions.

The term “excess capacity” encompasses any unused or underutilized transmission capability of an electromagnetic or other emanation, including a main or primary frequency band, subcarriers and sidebands. If a network is completely unused at a given moment in time, the invention may utilize 100% of the capacity of the network. This data or information may be conveyed in addition to the conventional signal or broadcast, or instead of the conventional signal or broadcast.

An Operations Center

One embodiment of the invention includes an Operations Center. In this Specification and in the Claims that follow, the term “Operations Center” encompasses any hardware, software, facility or switching, routing or transmitting node which may be used to implement the Invention. In one embodiment of the invention, information is conveyed from the data source to the Operations Center using wired, wireless or other communications links. The Operations Center may be co-located at the source of the data, or at a node within the network of transmitters.

Database Monitoring Software

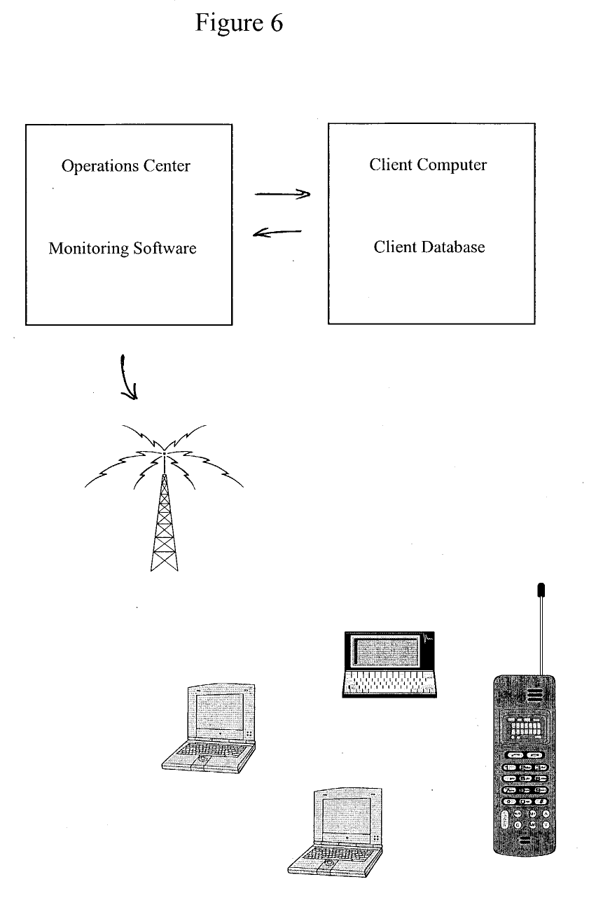

As shown in FIG. 6, one embodiment of the invention includes software for automatically and generally continuously monitoring information or a database maintained by a data source or client. A connection is provided to the database operated and maintained by a client. In accordance with one aspect of the invention, monitoring software constantly detects any real-time changes of any entries in the database. All of these changes are generally immediately conveyed to all the wireless terminals possessed by individuals who need access to current, accurate and updated information.

Gradual Transmission

The information updates may be conveyed from an Operations Center to a network of transmitters. The data is gradually conveyed by these transmitters to conventional wireless receivers that have been adapted to receive the updates using additional hardware, or to wireless terminals with a built-in capability to receive the updates. Unlike conventional broadcasts, the information updates are inserted, inj ected or otherwise combined at low data rates with conventional broadcast content using sidebands, subcarriers or other unutilized transmission capacity within a conventional broadcast signal. In one embodiment of the invention, entire databases may be conveyed to the wireless terminals. In another embodiment, the gradual conveyance of information is primarily focuses on the delivery of updates. The “RainBarrel™ Method” is described in greater detail in Section III of this Specification.

Database & Update Deliveries

In one embodiment of the invention, a person receiving a wireless terminal for the first time is able to access the database he or she needs immediately, since all the information is stored in the memory of the terminal before it leaves the factory. Alternatively, a complete library of information or a database could be downloaded from the Internet, and then the present invention could be used to maintain that information or database with updates. The present invention is then used to maintain the database with generally continuous updates.

Conventional Terminals Combined with Hardware Add-Ons

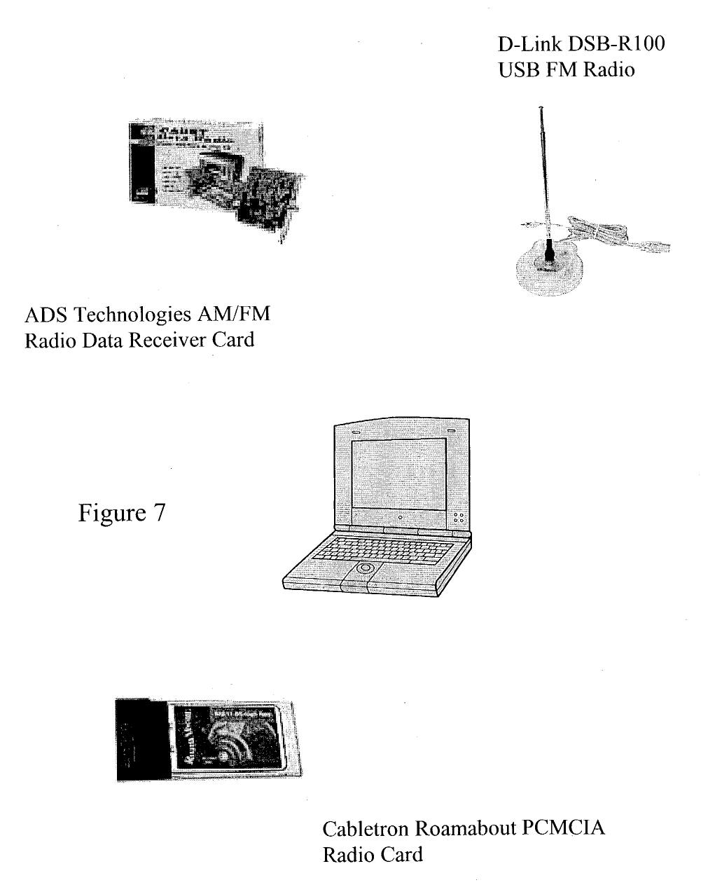

In another embodiment, an individual may use his or her existing electronic device, coupled with special hardware that implements the invention. As an example, an individual may add a specially adapted “radio card” to his or her personal computer. This radio card receives AM and FM broadcasts, and directs the demodulated signal into the motherboard of a personal computer. An example of a conventional radio card is shown in FIG. 7. The card shown in FIG. 7 is an ADS Technologies™ ISA8 8 MB-Ram ID Logic Plug-and-Play Cadet AM/FM Radio Data Receiver Card, and is currently available in the commercial market.

Another add-on device which enables radio reception for a computer terminal like a laptop or tablet is a USB radio. This device, as shown in FIG. 7, plugs into a USB port. The specific device depicted in FIG. 7 is a D-Link™ DSB-R100 USB FM Radio with MP3 Software, and is readily available in the commercial market.

Yet another add-on device which enables radio reception for a laptop or tablet computer is a PCMCIA card, such as that shown in FIG. 7. This particular product is a Cabletron Roamabout™ 128 Bit Encrypt PC PCMCIA Radio Card, which is available in the commercial market.

The three devices shown in FIG. 7 are conventional devices that are designed to receive conventional radio broadcasts. By replacing the primary receiver chip in these devices with a specialized chip that enables the implementation of the invention, an individual could retrofit his existing computer to receive continuously updated information.

Information Filters

Some persons receiving the generally continuous flow of information may not need or wish to view all of it. In one embodiment of the invention, the user of a terminal may activate a “filter” to select only a portion of all the available information. A user is able to select the categories or classes of information which are to be stored in his or her terminal by choosing from a menu of selections, or by customizing the flow of data. This selection can be made using a visual display, and some type of input device like a dial keypad, a keyboard, a stylus, a touchscreen or voice commands. The use of a filter can save storage space on the terminal, and make it easier to use by restricting the database to only that information which is relevant to the person who uses it.

II. Secure Communications

In one embodiment of the invention, the receiver may include a security chip which may be used to regulate the use of data or content and/or to thwart unauthorized copying or playing of received information. The reader is invited to refer to U.S. patent application Ser. No. 09/887,570, filed on Jun. 22, 2001; and to PCT International Patent Application No. PCT/GB02/005612 filed on Dec. 11, 2002, both entitled MethodforSecureDelivery ofDigital Content. These commonly-owned and commonly-assigned Patent Applications describe the UltraSecure™ Digital Rights Management & Key Protection System, and the contents of these two Applications are hereby incorporated by reference into this Application.

This security system may be combined with a back-channel from the wireless terminal back to the network to provide secure return communications from wireless terminals.

Both RainBarrel and UltraSecure are Trade and Service Marks owned by the assignee of this Patent Application.

III. The RainBarrel™ Distribution Method

Preferred & Alternative Implementations of the Invention

General Hardware Requirements

In one embodiment of the invention, the wireless receiver is specially configured to receive a “secondary channel” of gradually conveyed information. This secondary channel may be transmitted in addition to a primary channel. As an example, the primary channel in an FM broadcast is the conventional audio program. In general, the wireless receiver includes a specialized circuit or chip that is able to detect and separate the primary and secondary channels, and then save the information stream arriving in the secondary channel to the memory.

In an alternative embodiment of the invention, the entire capacity of a transmitter may be utilized to deliver information and/or updates. In this case, the entire primary channel is detected, and then saved in memory.

If the user generally performs his work outside, the stream of information may be received directly from a satellite in orbit. This alternative implementation would require the use of a separate receiver that would connect to the terminal that would store and display the information. As an example, some satellite phones are able to receive signals directly from satellite transponders, and would be suitable for this purpose.

FM Broadcast Station Channels

The frequency modulation (FM) broadcast band in the US ranges from 88 to 108 MHz. The band is divided into 100 channels of 200 kHz bandwidth each. The channel center frequencies are given by:

f₀=88.1+n×0.2 MHz where n=0 to 99 Equation (1)

In the U.S., 47 CFR 73.293 authorizes FM broadcast stations to “transmit subcarrier communications services.” One implementation of data delivery using FM radio broadcasting stations is a subcarrier at the channel center frequency modulated by a shaped-offset, Quadraphase Shift Keying (QPSK) waveform, with shape factor of 1.25, at 80 kbps. This provides a 160 kbps transmission rate of raw data. The delivered data is partitioned into 512 byte (4,096 bit) packets. The first twelve bytes of each packet are used for synchronization, address and flag fields. The remaining 500 bytes contain payload data with rate ⅘ turbo code, FEC. The resulting data transmission rate is 125 kbps, or 1.36 gigabytes (GBytes) per day for one FM broadcasting station.

AM Broadcasting Station Channels

The amplitude modulation (AM) radio broadcast band in the US ranges from 535 to 1705 kHz. It is divided into 117 channels of 10 kHz bandwidth each. Center frequencies in kHz are given by:

f₀=540+n×10 kHz for n=0 to 116 Equation (2)

AM broadcasting stations transmit at 50 kilowatts. In the US, 47 CFR 73.127 authorizes AM broadcast stations “to transmit signals not audible on ordinary consumer receivers, for both broadcast and non-broadcast purposes.”

One implementation of data delivery using AM broadcasting stations is a subcarrier at the channel center frequency modulated by a 256-Quadrature Amplitude Modulation (QAM) waveform, with shape factor 1.25, at 8 kilobits per second (kbps). This provides a 64 kbps transmission rate of raw data. The symbols are trellis-coded at rate ⅞ to provide FEC, resulting in a data rate of 56 kbps. The data is partitioned into 512 byte (4,096 bit) packets. The first 16 bytes of each packet are used for synchronization, address and flag fields. The remaining 496 bytes contain data. The resulting data transmission rate is 64.25 kbps, or 585.9 MBytes per day for each AM radio station.

Cellular CDPD

The Cellular Digital Packet Data (CDPD) network provides digital data over existing North American cellular networks by taking advantage of the idle time on analog AMPS channels to transmit packet data at 19.2 kbps. There are 666 AMPS channels between 870 and 890 MHz in the forward direction, and between 825 and 345 MHz in the reverse direction. The channels have 30 kHz bandwidths. There are 42 radio frequency (RF) control channels which cannot be used for CDPD. The data is Gaussian Minimum Shift Keying (GMSK) modulated with a bandwidth time product (BT) of 0.5. CDPD supports two-way communication, so only minimal FEC is required. Allowing 1.2 kbps for packet overhead and FEC, there remains eighteen kbps for data transmission, or 194 MBytes of data per day, per cellular channel used.

Local, Non-Standard Data Delivery Methods

FM Subcarriers

47 CFR 73.293 authorizes FM broadcast stations to “transmit subcarrier communications services in the United States.” Broadcast FM stations have been using subcarriers since the 1950's for things like Muzak music delivered to individual and company subscribers. Data broadcasting is more recent, but already in use for things like differential Global Positioning System (GPS) corrections, traffic data, stock quotes, etc.

One implementation of data delivery by FM subcarrier is the Radio Broadcast Data System (RBDS). A 57 kHz subcarrier is used, which is amplitude modulated by shaped biphase, differentially-coded, encoded digital data at 1.1875 kbps. The baseband data is packetized into groups of 104 bits. Each group is divided into 4 blocks of 26 bits each, and each block is further divided into 18 data bits and 10 check bits. This results in a 0.615 code rate, and a 730.8 bps information rate. Data transmission of this type is 7.9 MBytes per day.

Another implementation is Data Radio Channel (DARC). A 76 kHz Level Minimum Shift Keying (LMSK) subcarrier, modulated at 16 kbps raw bit rate, is injected into the composite FM signal at 10% modulation (−20 dB). The 16 kbps raw bit rate is equivalent to 173 MBytes per day. Adding frame and address overhead at 20%, and rate_forward error correction, a data rate of 10 kbps, or 108 MBytes per day can be achieved. A more efficient modulation scheme can provide a 56 kbps raw bit rate, equivalent to a 35 kbps data transmission rate, or 378 MBytes of data delivery per day per FM station.

AM Subcarriers

In the U.S., 47 CFR 73.127 authorizes AM broadcast stations to transmit subcarriers.

IV. A Specific Implementation of the Invention Using a Paging Network

In one embodiment of the invention, a paging network such as that operated by WorldCom's SkyTel®, Arch Wireless® or Metrocall Wireless® may be utilized to distribute content using the RainBarrel™ Method.

Information may be conveyed over wired or wireless links to an input, node or Operations Center of a national paging network. This content is conveyed to specially configured receivers whenever network capacity for transmitting RainBarreled content is available. In some instances, when the network traffic is zero, RainBarrel transmissions may utilize 100% of the network capacity. RainBarreled content may be conveyed instead of, or in addition to, the conventional primary paging signals; and users with receivers may receive, consume or use either the primary paging signals, the secondary RainBarrel content, or both. Conventional paging messages may be assigned priority over RainBarrel™ content, which comprise digital packets that may be re-ordered by the receiver if the RainBarrel™ stream is interrupted or if packets are received out of order. Rebroadcasting or error checking methods may also be employed to insure the integrity of the RainBarrel™ content.

Current paging systems comprise regional or nationwide networks of transmitters that can provide over 90% geographical coverage of the United States. Many of these systems operate in the 900 MHz bands. Receivers do not generally require an external antenna. Conventional paging systems may provide numeric paging, text messages, wireless e-mail, telemetry and interactive two-way messaging.

One of the protocols which governs paging system communications is known as “ReFLEX50,” developed by Motorola®. ReFLEX50 enables messages to be transmitted on an outbound channel from the transmission tower to a receiver at a data rate of 25.6 kbps in a 50 kHz channel comprising four subchannels of 6.4 kbps. ReFLEX50 also provides a response link back from the receiver with a data rate of 9.6 kbps signal in a 12.5 kHz channel. This outbound data rate of 25.6 thousand bits per second (kbps) is capable of providing content delivery totals of 1,536 kb per minute, 92,160 kb per hour, 2,211,840 kb per day, roughly 2.2 Gb per day or about 66 Gb per month. Higher total content deliveries for a given time period may be obtained by RainBarreling content to a receiver using more than one channel at the same time. As examples, two simultaneous delivery channels could convey 132 Gb per month, while four channels would convey about 265 Gb per month.

The return link from the receiver back to the transmitter which is normally used in two-way paging may be utilized for RainBarrel messages, including account authorizations and verification. This feature would be used when the content transmitted needs to be safeguarded against authorized playing or use. The back-channel may be used to verify the good standing of a customer's account, or also may be used to convey keys or key information that is used by the receiver's security chip to decrypt an encrypted file of content. For more details concerning the use of the back channel to thwart unauthorized use and copying of content, the reader is invited to refer to U.S. patent application Ser. No. 09/887,570, filed on Jun. 22, 2001; and to PCT International Patent Application No. PCT/GB02/005612 filed on May 23, 2001, both entitled Method for Secure Delivery of Digital Content, filed on Dec. 11, 2002. These commonly-owned and commonly-assigned Patent Applications describe the UltraSecure™ Digital Rights Management & Key Protection System.

Although this section of the Specification describes a specific implementation using a paging network, the RainBarreled content that may be conveyed using this network is not limited to any particular type of transmitted electronic payload. The content may comprise any form of digital information or signal, including movies, images, music, video games, software, audio programs, books, newspapers, periodicals, manuals or any other form or manifestation of data, writing, image, intelligence, sensing or impression.

V. A Specific Implementation of the Invention Using a Cellular Network

In one embodiment of the invention, a cellular telephone network such as that operated by Sprint®, MCI-WorldCom®, AT&T®, Cingular®, Nextel®, T-Mobile® or Verizon® may be utilized to distribute content using the RainBarrel™ Method. Information may be conveyed over wired or wireless links to an input, node or Operations Center of a national cellular network. This content is conveyed to specially configured receivers whenever network capacity for transmitting RainBarreled content is available. RainBarreled content maybe conveyed instead of, or in addition to, the conventional primary cellular telephone signals; and users with receivers may receive, consume or use either the primary cellular telephone signals, the secondary RainBarrel content, or both. This content is conveyed to receivers whenever network capacity is available. In some instances, when the network traffic is zero, RainBarrel transmissions may utilize 100% of the network capacity. Conventional telephone calls may be assigned priority over RainBarrel™ content, which comprise digital packets that may be re-ordered by the receiver if the RainBarrel™ stream is interrupted or if packets are received out of order. Rebroadcasting or error checking methods may also be employed to insure the integrity of the RainBarrel™ content.

Current cellular systems comprise regional or nationwide networks of transmitters that can provide over 90% geographical coverage of the United States. Many of these systems operate in the 900, 1800 or 1900 MHz bands. Some PCS or other advanced systems operate at even higher frequencies. Receivers may be configured so that they do not require external antenna.

Cell phone systems generally employ the Cellular Digital Packet Data (CDPD) protocol, which can operate at data rates up to 19.2 kbps. This outbound data rate of 19.2 thousand bits per second (kbps) is capable of providing content delivery totals of 1,152 kb perminute, 69,120 kb perhour, 1,658,880 kbper day, orroughly 1.6 Gb per day or about 50 Gb per month. Higher total content deliveries for a given time period may be obtained by RainBarreling content to a receiver using more than one cellular channel at the same time. As examples, two simultaneous delivery channels could convey approximately 100 Gb per month, while four channels would convey about 200 Gb per month.

The return link from the receiver back to the transmitter that would normally be used for the portion of the telephone call that is sent from the user's phone back to the cellular tower may be utilized for RainBarrel account authorizations and verification. This feature would be used when the content transmitted needs to be safeguarded against authorized playing or use. The back-channel may be used to verify the good standing of a customer's account, or also may be used to convey keys or key information that is used by the receiver's security chip to decrypt an encrypted file of content. For more details concerning the use of the back channel to thwart unauthorized use and copying of content, the reader is invited to refer to U.S. patent application Ser. No. 09/887,570, filed on Jun, 22, 2001; and to PCT International Patent Application No. PCT/US01/14828 filed on May 23, 2001, both entitled Method for Secure Delivery of Digital Content. These commonly-owned and commonly-assigned Patent Applications describe the UltraSecure™ Digital Rights Management

& Key Protection System.

Although this section of the Specification describes a specific implementation using a cellular telephone network, the RainBarreled content that may be conveyed using this network is not limited to any particular type of transmitted electronic payload. The content may comprise any form of digital information or signal, including movies, images, music, video games, software, audio programs, books, newspapers, periodicals, manuals or any other form or manifestation of data, writing, image, intelligence, sensing or impression.

VI. A Specific Implementation of the Invention Using Satellite Phones

In another embodiment of the invention, workers in remote regions may receive pushed streams of information directly from satellites. Thuraya, Guruda, Globalstar, Inmarsat and Iridium offer commercial satellite coverage. Motorola and Ericsson provide handheld satellite phones. These phones may be connected to laptop computers to receive the pushed stream of information.

### CONCLUSION

Although the present invention has been described in detail with reference to one or more preferred embodiments, persons possessing ordinary skill in the art to which this invention pertains will appreciate that various modifications and enhancements maybe made without departing from the spirit and scope of the Claims that follow. The various alternatives for providing a-highly secure data distribution system that have been disclosed above are intended to educate the reader about preferred embodiments of the invention, and are not intended to constrain the limits of the invention or the scope of claims.

What is claimed is:

1. A method comprising the steps of:
conveying of set of information from a source to a remote location;
distributing said set of information to a wireless terminal at said remote location using a point-to-multi-point transmitter; and
automatically and wirelessly pushing said set of information to said wireless terminal in said remote location;
said receiver including a memory; said memory for storing said set of information.

2. A method as recited in claim 1, in which said set of information is conveyed generally simultaneously to a plurality of wireless receivers in said remote location.

3. A method as recited in claim 1, in which said set of information includes an update to previously stored information in said memory of said wireless terminal.

4. A method as recited in claim 1, in which said set of information includes new information which is different from previously stored information in said memory of said wireless terminal.

5. A method as recited in claim 1, in which said set of information is conveyed using the excess capacity of an existing network.

6. A method as recited in claim 1, in which said set of information is transmitted using substantially all of the capacity of an existing network.

7. A method as recited in claim 6, in which said existing network includes an FM transmitter.

8. A method as recited in claim 7, in which said set of information is transmitted using an FM subcarrier.

9. A method as recited in claim 7, in which said set of information is transmitted using an FM sideband.

10. A method as recited in claim 5, in which said existing network includes a paging system.

11. A method as recited in claim 1, in which a satellite is also employed to convey said set of information.

12. A method as recited in claim 1, in which said wireless terminal includes a filter for selecting which of said set of information is selected to be saved in said memory of said wireless terminal.

13. A method as recited in claim 1, in which said wireless terminal also includes a return channel for a message from a user back to said network.

14. A method including the steps of:
providing a plurality of wireless terminals at a remote construction site; each of said terminals including a memory; each of said memories for storing a database; and
pushing a set of information from a local source through a network to said plurality of wireless terminals to automatically and generally continuously update said database.

15. A method as recited in claim 14, further including the step of:
loading an initial set of information on one of said wireless terminals using a hard-wired connection.

16. A method as recited in claim 14, further including the step of:
selectively storing information in one of said wireless terminals by using a software filter.

17. A propagated signal comprising:
a plurality of data updates;
said plurality of data updates being conveyed over a point-to-multi-point network to a wireless terminals;
said wireless terminals being located at a construction site which has inadequate communications facilities.

18. An apparatus comprising:
a transmitter means for broadcasting data received from a source;
a wireless terminal means for receiving; said wireless terminal having a memory means for storing data; said wireless terminal means being generally located at a remote construction site; and
said transmitter means for conveying pushed data updates to said wireless terminal means.

19. An apparatus as recited in claim 18, in which said transmitter means is connected to a software monitoring means for detecting changes in a construction information database.
